(19) United States
(12) Patent Application Publication
(10) Pub. No.: US 2006/0068753 A1
(43) Pub. Date: Mar. 30, 2006

(54) Emergency call handling system

(76) Inventors: Jim Karpen, Loudonville, NY (US); Brian St. Jean, Barrie (CA); Guy Roe, Manlius, NY (US); John McCarthy, Troy, NY (US); Rick Loffredo, Averill Park, NY (US); Dave Pratt, Stillwater, NY (US)

Correspondence Address: DICKSTEIN SHAPIRO MORIN & OSHINSKY LLP, 2101 L Street, NW, Washington, DC, 20037, US

(21) Appl. No.: 11/227,262

(22) Filed: Sep. 16, 2005

Related U.S. Application Data
(60) Provisional application No. 60/611,801, filed on Sep. 22, 2004.

(51) Int. Cl. H04M 11/04

(52) U.S. Cl. 455/404.2

(57) ABSTRACT

An emergency call handling system and method that accepts emergency services requests (e.g., 9-1-1 calls), routes and delivers them to appropriate emergency services call takers (e.g., Public Safety Answer Points or “PSAP” and other appropriate recipients). The centralized design of the system provides additional functionality such as emergency management capabilities.

This application claims priority to provisional application No. 60/611,801, filed on Sep. 22, 2004, which is hereby incorporated by reference in its entirety.

### FIELD OF THE INVENTION

The invention relates to an emergency call handling system intended for use within the United States (or other countries with similar emergency call handling services) to accept emergency services requests (e.g., 9-1-1 calls), route and deliver them to appropriate emergency services call takers (e.g., Public Safety Answering Points or “PSAPs” and other appropriate recipients). The centralized design of the system provides additional functionality such as emergency management capabilities.

### BACKGROUND OF THE INVENTION

Current 9-1-1 Systems rely on analog Centralized Automated Message Accounting (CAMA) technology developed in the 1950s for the purpose of billing for long distance services. This system was adapted for use with 9-1-1, providing the Automatic Number Identification (ANI) of the calling number only with a maximum of 10 digits possible. To provide Automatic Location Information (ALI), a system of separate, low speed data circuits was developed to associate the ANI with the ALI needed for emergency response. This system was adequate for initial wireline 9-1-1 systems but has since proven inadequate for future systems. (See Dale N. Hatfield, Report on Technical and Operational Issues Impacting the Provision of Wireless Enhanced 911 Services, before the Federal Communications Commission, Oct. 15, 2002).

Since the initial implementations for wireline, a multitude of new communications options have become available. Among these are wireless or cellular telephones, Voice over Internet Protocol (VoIP) or Internet telephones and various forms of data communications such as multimedia communications, Instant Messaging and Telematics. Various workarounds have been developed for fitting wireless and VoIP telephones into the existing wireline structure but newer digital technologies cannot be adequately handled by the existing analog systems.

Transmission Control Protocol (TCP) and Internet Protocol (IP, or together TCP/IP) technology is widely recognized as the future of 9-1-1 (i3, the IP enabled “PSAP of the future”). IP systems are not limited in the amount of data that can arrive with the call (as opposed to via a separate data path) and they can be used for multiple shared systems, including data and radio, thus reducing operating costs and complexity. Additionally, IP systems are multi-directional (as opposed to bi-directional lines between the PSAP and the Telephone Central Office (CO)), simplifying data sharing, including call transfers (with the associated data). Properly implemented, IP systems also offer reduced call set up times (eliminating CAMA delays), thus getting the call to the appropriate emergency responder more quickly (a desirable result in the event of an emergency situation).

The proliferation of devices and technologies using IP also creates a need to be able to locate all IP devices (not just IP phones) and validate those locations against a Master Location Database (MLDB) so that 9-1-1 can be reached consistently by any device, any time, anywhere.

### SUMMARY OF THE INVENTION

The invention relates to an emergency call handling system and method that accepts emergency service requests (e.g., 9-1-1 calls) from a variety of voice and data input sources, determines the appropriate responding emergency services based on the location of the requestor, and delivers the request and request data to the appropriate Public Safety Answer Point, which will communicate the data to the appropriate responding agency based on location. The invention allows adding new call and data originators and recipients to the system. Implementation at the PSAP/data recipient is greatly simplified and, accordingly, new technologies can be implemented more quickly and easily and at reduced cost. The multi-directional nature of the IP system allows data previously available only at the PSAP to be shared among many other recipients that may have need of this information. This data sharing capability greatly enhances emergency response, particularly in large scale or multi jurisdictional events. One embodiment of the emergency call handling system provides centralized storage of emergency request information and an emergency management capability.

It is an object of the invention to provide an emergency call handling system.

It is an object of the invention to provide an emergency call handling system capable of accepting inputs from all types of emergency services requests.

It is another object of the invention to provide a method of specifying the location of a digital device.

In one aspect of the invention, an emergency call handling system comprises a first subsystem for communicating with one or more types of emergency services requests; a second subsystem for determining an appropriate recipient for delivery of the types of emergency services requests; and a third subsystem providing call processing and IP-based delivery to emergency call answering locations.

In another aspect of the invention, an emergency services system comprises a database for storing emergency services request information; and means for monitoring emergency services request activity, wherein said system allows PSAP, regional, statewide, country-wide or even multi-national use of stored request information.

In yet another aspect of the invention, an emergency services system capable of accepting inputs from one or more types of emergency services requests comprising a means for accepting wireless calls, means for accepting data-only calls; means for accepting wireless calls, and means for translating localized information associated with the requests to a standard format.

In yet a further aspect of the invention, a method of specifying a digital device location comprising the steps of querying a location storage database based on an IP address and machine address code (MAC) of the device; determining if a known location of the device exists within the database; and providing to the user a map display, geocoordinates, a civil address, and additional emergency services information associated with the location.

In yet a further aspect of the invention, a method of communicating with non-IP based types of emergency requests comprising the steps of converting voice information from a request to a packet based voice over IP format; converting non-IP data to a packet based IP format, allowing multi-directional data flow between various system components; and delivering the data and voice information between the various system components using the IP formatted information.

In yet a further aspect of the invention, a method of determining an appropriate recipient of an emergency services request comprising the steps of determining a recipient for the request based on call information from one or more emergency services request originators, and delivering the request to the appropriate destination.

In yet a further aspect of the invention, a subsystem for storing information concerning the emergency services requests comprising one or more civil routing storing means, cell sector routing storing means, coordinate routing storing means, and means for storing information to support real time geocoding.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1 is a block master diagram of an exemplary emergency call handling system constructed in accordance with the invention;

FIG. 2 is a technical diagram of the exemplary emergency call handling system constructed in accordance with the invention;

FIG. 3 is a functional block diagram of an exemplary subsystems within the emergency call handling system constructed in accordance with the invention; and

FIG. 4 illustrates a process of determining and verifying the location of an IP device or system implemented in accordance with an embodiment of the invention.

### DETAILED DESCRIPTION OF THE INVENTION

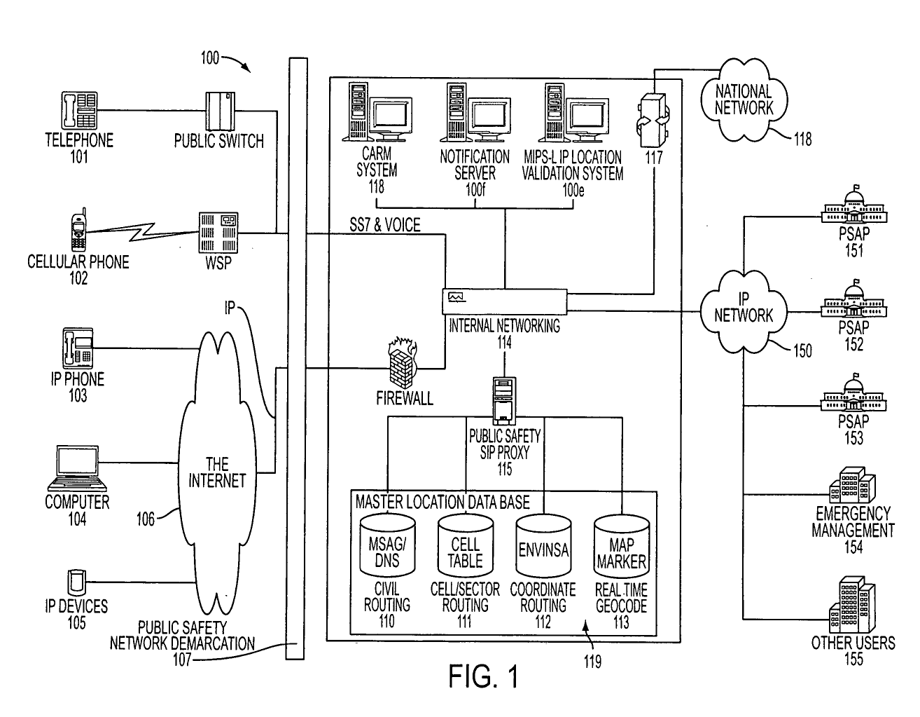

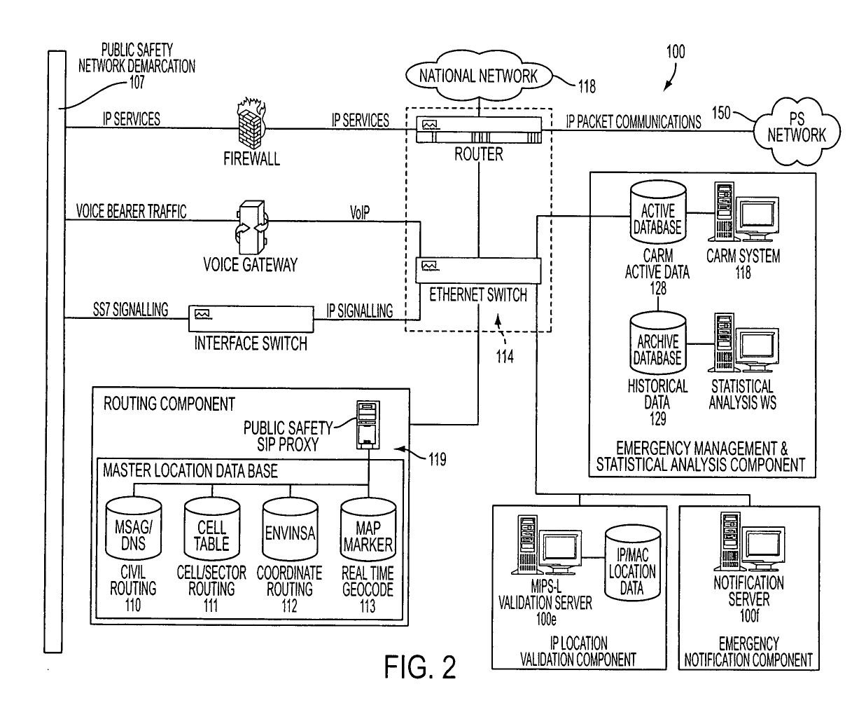

The basic capabilities of the emergency call handling system of the invention include the ability to accept emergency service requests (e.g., 9-1-1 calls) from a variety of voice and data input sources, determine the appropriate call answering service based on the location of the request or requestor, and deliver the request (i.e., call) and data to the appropriate service. A master block diagram of the system 100 of the invention is illustrated in FIG. 1. A technical diagram of the system 100 of the invention is illustrated in FIG. 2.

It should be appreciated that although the description refers to “requests,” the invention is capable of handling any emergency services request including calls, data or notifications whether alone or in any combination, from any type of device (e.g., an IP-based request from a digital device, wireless call, analog call, etc.) and is not limited to telephone calls. It should be appreciated that the invention may be used to handle any type of emergency services call, data request or notification.

The centralized system 100 provides a simple, unified point of access for new services to enter the system 100. The system 100 runs on an IP infrastructure and accepts various forms of emergency services requests converts them into an IP-based form for delivery to the appropriate service-providing/service-monitoring recipient (e.g., a PSAP 151). An IP-based system is capable of carrying voice (using voice over IP or “VoIP”), standard packet data, and radio packet data. The system 100 includes multiple routing mechanisms, based on the call information provided, as is discussed in more detail below.

The system 100 is capable of being deployed for regional, statewide, national and even multi-national coverage serving one or more PSAPs. Because IP/VoIP uses a packet data network, a single type of feed can carry all information flow to the connected PSAPs 151, 152 and 153 and other recipients 154 and 155.

The system 100's redundant call processing centers and infrastructure provides security and protects against connection and internal equipment failures. In the event of a failure at any one call processing center, the other center (or centers) have the capacity to operate the emergency call delivery system. The system 100 provides a single standards-based form of voice and data delivery for all emergency services requests.

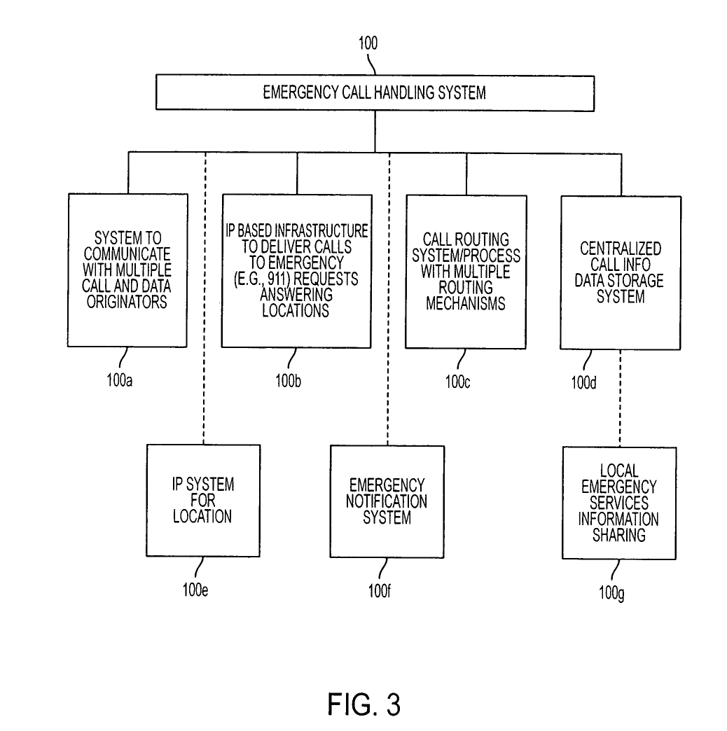

The system 100 is comprised of several subsystems, described below. The system arrangement may utilize any combination of these subsystems. A functional block diagram of these subsystems is illustrated in FIG. 3. The subsystems include a system that communicates with one or more request originators 100a, a dedicated, secure, and redundant IP based Infrastructure to deliver calls to emergency call answering locations 100b, a call routing system having one or more routing mechanisms 100c, a centralized call information data storage system 100d, and an IP system for feeding the system 100 with accurate location information 100e. Optional subsystems include an emergency notification system 100f and a local emergency services information sharing system 100g.

Referring now to FIGS. 1 and 2, the system 100 accepts one or more different types of emergency services requests. For example, the system 100 can interface with landline and wireless telephones 101, 102 or IP-based devices such as a digital phone 103, computer 104 and other IP devices 105 (e.g., PDA or Blackberry™), known or being developed. IP devices (e.g., 103, 104 and 105) can communicate with the system via the internet 106. A public safety network demarcation 107 is also shown in FIG. 1 and FIG. 2.

The system 100 accepts and routes wireless calls independent of carrier/technologies. The system 100 accepts and routes wireless calls from current standard equipment and systems, in standard as well as non-standard current forms, and IP-based methods. The system 100 also accepts and routes emerging technologies including, but not limited to, VoIP, ONSTAR and similar services, instant messaging systems, satellite telephones, etc. The system also accepts ONSTAR and similar accident notices, gunshot detectors, automatic alarms, as well as wired and wireless network devices (e.g., WiFi (wireless fidelity devices)) including the computers 104, and portable devices 105. Additionally, the system 100 accepts standard wireline delivery of emergency calls based on SS7 and CAMA (centralized automatic message accounting) from e.g., a standard telephone 101.

Once the emergency request enters the system, all internal communications are made via IP-based technologies. A key to this IP-based infrastructure is conversion of a voice communication from the format in which it arrives to a packet based VoIP format. All voice communications are delivered in the system using VoIP. The system 100 uses Session Initiation Protocol (SIP) (using server 115) for signaling and delivery of the data and voice information between various system components involved in call processing and delivery. The system 100 allows multi-directional data flow to and from any of the system components e.g., voice XML server 116, CARM system 118 via network switching and controlling equipment 114. In particular, the invention uses an IP network to provide a web of integrated, interactive communication services. Additionally, the system 100 uses a gateway 117 to connect the IP network components to a national network 120.

The emergency call handling system of the invention can share its IP transport mechanism among numerous applications, allowing the cost of transport to be significantly reduced compared to dedicated telephone company lines or IP connections. The ability of the IP infrastructure to employ dynamic allocation of bandwidth allows more cost effective deployment. In addition, by its very nature, IP dynamic routing of data packets increases the survivability of the network.

The IP network of the invention supports radio packets and supports the delivery of the request to any appropriate recipient (e.g., hospitals, federal, state, and local governmental entities).

The system interfaces with local PSAPs 151, 152 and 153, emergency management organizations 154, and other service providers/recipients 155 responsible for handling and or monitoring emergency services. An IP network 150 connects the recipients 151, 152, 153, 154 and 155 to the system 100.

The IP transport mechanisms of the invention allow the PSAP/recipient 151-155 to add local information into a central data store 128. It should also be appreciated that the local information could be temporarily stored in central data store 128 and then later archived in a second central data store 129.

PSAPs currently have a great deal of information that “dead ends” at the PSAP/recipient 151-155. Information such as response vehicle location data, CAD (computer aided dispatch) incidents and other PSAP/recipient based information can be shared over the IP infrastructure 150. The IP transport mechanism provides a single, standardized form of voice and data flow to the PSAP/recipients 151-155. A single type of feed reduces cost and complexity at the PSAP/recipient 151-155. Individual PSAPs 151, 152 and 153 would no longer have to react and adapt to new forms of communications, as individual PSAPs 151, 152 and 153 would automatically communicate with the system 100 and delivery would be in a standard format over established IP connections.

By using a shared IP transport for all communications, the cost of telephone company lines and switches can be eliminated. The IP transport mechanism of the invention uses IP-based software or IP-based telephones for PSAP/recipient 151, 152 and 153 voice communications instead of using a myriad of telephone company switches and systems. PSAP/recipient's could be equipped with VoIP soft clients that would run on their internal IP networks.

The system 100 determines the correct/appropriate PSAP/recipient to which to deliver the emergency services request and delivers the request. The system 100 accepts one or more of the emergency services request and holds the emergency services request temporarily, while a routing determination is made, and then sends the request. The system 100 has the ability to reach out to other information sources (discussed in more detail below) if necessary to gather information regarding the request.

Based on the incoming request information, the system 100 determines the destination for the request or holds it while it reaches out to other information sources for information on the request. Any other information received can also be used in the destination determination. Once an appropriate PSAP/recipient is determined, the system 100 of the invention delivers the request to the destination. This allows the system, for example, to reach out to the wireless carrier to access mobile phone location (latitude/longitude), or, to geocode a civil address for use in the routing determination. Once a location is determined, the information is delivered to a PSAP 151, 152 and 153 or other EMS recipient 154 and 155 using the IP network 150.

A preferred mechanism of providing this capability is using a SIP proxy inside a Call Agent, which is a specific IP-based approach to accessing request information, and routing the request. The process allows both initial information requests as well as periodic additional requests to be handled and delivered to the PSAP/recipient (e.g., a request on initiation, and during the request (to keep the system and PSAP/recipient updated with current location of moving callers)).

Referring again to FIGS. 1 and 2, the MLDB 119 of the invention contains civil routing 110, cell/sector routing 111, coordinate routing 112, and real time geocode 113 information. The system 100 of the invention is designed as a public safety communications and response system (as opposed to a single purpose response to a specific problem such as e.g., wireless E9-1-1 or VoIP). The system 100 and method of the invention are capable of handling many of the potential routing situations that may arise, including any of the following.

One method provides a current technology table lookup of previously validated address data in the MSAG 110, a standardized table generated by local emergency services (e.g., 9-1-1), associates the given address data, i.e., a street address, to a PSAP. In other words, the Call Routing System of the invention determines the PSAP given an MSAG address by table lookup 110.

Another method involves cell/sector routing using cell/sector information 111 for wireless phones. This is accomplished through table look up, or geographic lookup based on cell tower/face location/coverage coordinates. This method provides table-based routing based on the location of the receiving cell tower and, if available, sector. This is a failover for those occasions when coordinate location of wireless callers is unavailable (coordinate based routing is discussed below).

Coordinate based routing using coordinate routing information 112 performs a point in polygon or similar spatial analysis to find the PSAP associated with a latitude/longitude position. Coordinate based routing can be performed when the call is wireless, VoIP, or anytime a coordinate based location (latitude/longitude) is available. For example, given a mobile caller's latitude/longitude (X/Y) and a set of geographically defined PSAP boundaries, the system determines the appropriate PSAP. The coordinate based routing process is also capable of routing VoIP calls as well as future communications that provide X/Y coordinate locations for callers (ONSTAR, etc.) In the case of VoIP, some devices will provide coordinate positions based on GPS technology, and some will provide coordinates based on triangulation or other network based methods.

Current equipment is limited in its ability to deal with variations from the MSAG (e.g., 123 Main St may be valid but 123 Main Street may not). Thus, as an alternative, a form of routing based on a civil address is possible through the system. Given an address from a source that is not MSAG verified or validated (for example, a VoIP client entering their home address into the VoIP emergency response information system), the system will geocode the address, determine the latitude/longitude and then determine the PSAP or other recipient 151-155 via a coordinate based routing search. This system would perform what is known as a real time geocoding of non-MSAG valid addresses.

The system creates a master location database that incorporates all appropriate location databases (e.g. MSAGs, cell/sector location tables, etc.) for the coverage area. Thus, the system can provide a greater amount of information in a centralized location. Provisions for a geocode location can be provided in real-time.

Moreover, the system can reach out or point to third party services for additional information that may be needed to handle the emergency. For example, if a chemical plant has a chemical at its facility, the system of the invention has the ability to see if there is additional information associated with the chemical plant (or the chemical). This information may be retrieved and forwarded to a recipient so that the recipient may evaluate potential additional risks. Moreover, the system can point recipients to additional medical records, police reports, etc. associated with the requestor or location. It should be appreciated that the system can point PSAPs to any type of additional information and the invention is not limited to the foregoing list.

The call routing portion of the call handling system 100 of the invention can support routing of the call and/or data to any appropriate recipient. This system also has the ability to store information for both active emergency services calls and associated data for the areas that are served by the call handling system 100. Both real time information and completed call information can be stored in separate, but logically connected, automated databases. The stored data is intended to be accessed and analyzed by other applications of the system 100. The routing component 119 provides the ability for the call handling system 100 to allow transfers of calls and associated data to any PSAP 151, 152 and 153 or recipient 154 and 155 connected to the system 100.

The invention also comprises a local emergency services information sharing system, which provides the capability for information created or accessible at one PSAP, or emergency services facility, to be accessed through the system 100 via the IP infrastructure by other PSAPs and other emergency services facilities. Thus, the emergency handling system 100 of the invention provides this information to a larger audience.

The centralized and IP-based aspects of the call handling system 100 of the invention described above allow the ability to provide a new class of emergency handling systems. The systems allow PSAP, regional, statewide, country-wide or even multi-national viewing of active call information and other information previously accessible only at the PSAP. These systems rely on several emergency call and notification system capabilities such as a database 128 capable of storing active call information (e.g., the centralized emergency services and call info data storage system) and a mechanism to allow PSAP's and other potential data sources to feed local data into the database (e.g., Local Emergency Services Information Sharing System).

It should also be appreciated that the invention may also comprise an emergency notification system, which allows notification of the public of emergency situations within a defined area. Notification can occur through any device connected to the system 100 (i.e., telephones 101 and 102 or IP-based devices 103, 104 and 105.

The system can use one or more applications, capable of accessing, analyzing, and reporting this information to other responsible parties, such as a state emergency management office, via known web based technologies.

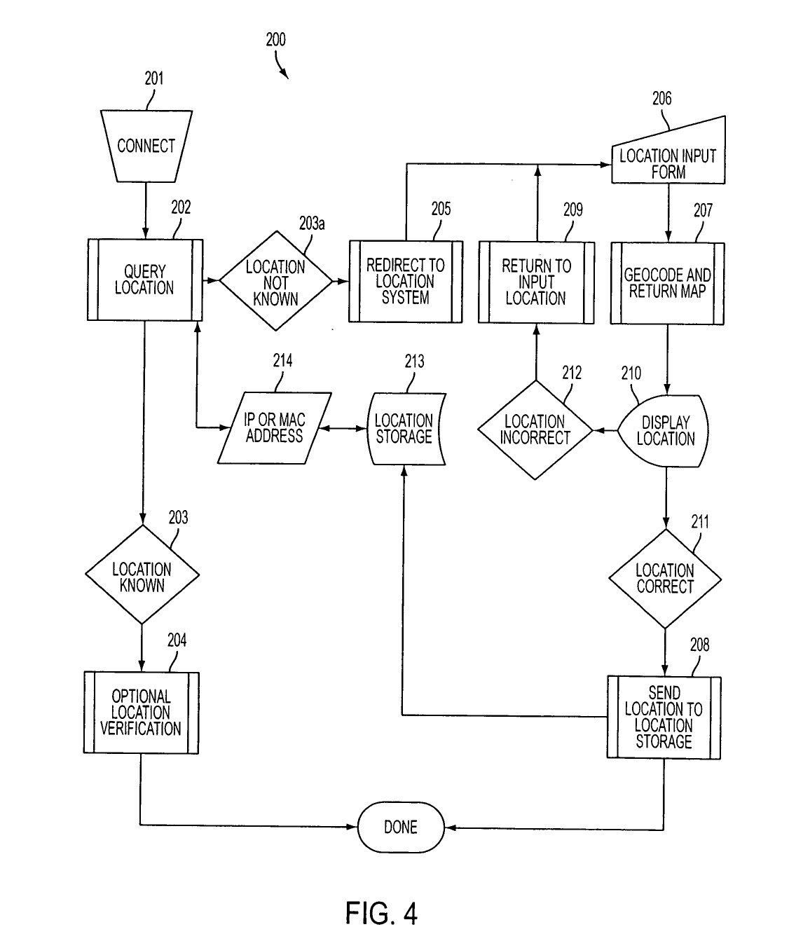

Referring now to FIG. 4, a key component of routing 9-1-1 or other emergency services requests is determining the location of the party requesting the services. The invention includes an IP system for location (IPS-L) which is a system for specifying and storing the location of digital devices. The IPS-L system uses an easy to understand web interface to associate a particular device with a specific location. The process 200 of the IPS-L is now described.

When a device, for example a wireless access point (WAP) or other wireless fidelity (WiFi) device is desired to be associated with the invention or otherwise initially implemented, an initial connection is directed to an IPS-L server (step 202). In step 202, the IPS-L application (which may be operated by a private or public entity) queries a location storage device to see if the location of the wireless device, based on an Internet Protocol (IP) address, Machine Access Code (MAC) address, or both is known (i.e., stored in block 214). If the location is known (block 203), then no further action is necessary (although an optional verification step 204 is possible at this point). If the location is not known (block 203a), then the user is redirected (step 205) to a location input form to enter location and other identifying information (block 206).

After the user information is entered, in step 207, the IPS-L system determines the latitude and longitude of the wireless device location and, in some implementations, compares the civil address information against the Master Street Address Guide (MSAG) of a particular area or the Master Location Database (MLDB) 119 of the invention. Immediate feedback would be provided to the user in the form of a map display 210 and, where appropriate, a valid civil address confirmation. Additionally, the system will also perform an Emergency Services Routing lookup and return information regarding emergency responders to the user.

The user would then confirm that the location displayed was correct 211 and the location data would be entered automatically in the location storage database 213. If the location did not display or map correctly (step 212), in step 209, the user would be returned to the location input form to correct the location information. The system would offer possible options to correct the entry. Once confirmed, the location is stored (step 208) in a storage database (block 213) and associated with the IP device location (block 214).

Using the system, any IP or MAC address can be accurately located, not just VoIP devices operated through a VoIP Service Provider. The IPS-L solution could be deployed and operated by private enterprises, such as “wireless hot spot” providers, VoIP providers, educational institutions (public and private) and other Internet Access Providers to provide location information before the call enters the public 9-1-1 system. It could also be operated as part of a public sector system, such as an interim VoIP delivery solution, used as a Validation Database (VDB) with or without Emergency Service Zone Routing Database (ERDB).

Additionally, information that was unavailable outside of the PSAP can now be shared and utilized in new applications. Such additional applications include, but are not limited to, wireless and wireline call information, 7-digit CAD incident calls, unit location/status information from CAD, AVL (automatic vehicle location) and remote alarm monitoring. System 100 includes a translator (not shown) that has the ability to translate local codes into federal standardized codes such as the Uniform Crime Report (UCR), National Incident Based Reporting System (NIBRS) or National Fire Incident Reporting System (NFIRS) codes as the basis for sharing information between jurisdictions. This capability allows local PSAPs to study multi-jurisdictional trends and allows a standard, centralized data retrieval method for the PSAPs and other recipients.

Due to the invention's capability of handling multiple applications designed to use information in the centralized MLDB, the system 100 provides new levels of inter/multi-jurisdictional planning and cooperation. The centralized IP-based system 100 allows numerous jurisdictions the ability to share information that previously “dead ended” at the PSAP.

In addition to strategic planning such as unit deployment in multi-jurisdictional incidents, the emergency handling system of the invention can be used for tactical deployment of inter-jurisdictional resources such as deploying the “closest car.” This enhances public safety by allowing the nearest resources to respond to life threatening situations while reducing the risks to public safety and civilian population caused by long, high speed responses. Standardized incident/response codes would be used for a centralized emergency response system. The standardized codes allow jurisdictions to communicate and understand needed resources in other nearby jurisdictions using a standard format.

Another class of applications made possible through the centralized and IP-based aspects of the call handling system allows a user to monitor and/or analyze the transmitted information. Examples include the ability of automatically identifying PSAP/responding agency overload, and balancing of the system. Other capabilities include: investigation of call volume and call handling statistics; analysis of call types by time, day, location, etc.; identification of areas/location with high incident history; analysis of response times; analysis of response vehicle movements; and any other desired statistics.

Having described specific preferred embodiments of the invention with reference to the accompanying drawings, it is to be understood that the invention is not limited to those precise embodiments, and that various changes and modifications may be effected therein by one skilled in the art without departing from the scope or the spirit of the invention as defined in the appended claims.

What is claimed as new and desired to be protected by Letters Patent of the United States is:

1. An emergency call handling system comprising:
a first subsystem for communicating with one or more types of emergency services requests;
a second subsystem for determining an appropriate recipient for delivery of emergency services requests; and
a third subsystem providing IP-based call processing and delivery to one or more emergency call answering locations.

2. The system of claim 1, further comprising a fourth subsystem for storing information concerning the emergency services requests handled by the system.

3. The system of claim 1, wherein the subsystems are provided in redundant locations.

4. The system of claim 1 further comprising a local emergency services information sharing subsystem.

5. The system of claim 1, further comprising an emergency notification system.

6. An emergency services system comprising:
a database for storing emergency services request information; and
a means for monitoring emergency services request activity based on the stored request information,
wherein said system allows PSAP, regional, statewide, country-wide or multi-national access to the stored request information.

7. The system of claim 6, wherein said system is an IP-based system.

8. The system of claim 7, further comprising means for analyzing system capabilities based on the stored emergency services request information and data.

9. The system of claim 7, further comprising means for investigating call volume and handling statistics based on the stored emergency services request information and data.

10. The system of claim 7, further comprising means for analyzing call types by one of time, day, and location based on the stored emergency services request information and data.

11. The system of claim 7, further comprising means for identifying locations with high incident history based on the stored emergency services request information and data.

12. The system of claim 7, further comprising means for analyzing response times based on the stored emergency services request information and data.

13. The system of claim 7, further comprising means for allowing emergency services entities to input local data into the database.

14. The system of claim 13, wherein said system provides closest car information to appropriate emergency services providers.

15. The system of claim 13, further comprising means for analyzing vehicle response movement based on the stored input local data into the database.

16. The system of claim 13, further comprising means to view, monitor, and analyze other input data such as remote sensors and other future inputs.

17. An emergency call handling system for accepting input from one or more types of emergency services requests, said system comprising:
means for accepting wireless calls;
means for accepting IP-based requests;
means for accepting data-only calls;
means for accepting wireline calls; and
means for translating localized information associated with the requests to a standard format.

18. The system of claim 17, further comprising:
means for temporarily holding an accepted request;
means for determining a destination for the request; and
means for sending the request based on the determined destination.

19. The system of claim 18, further comprising means for obtaining information from external sources to gather information regarding the accepted request.

20. A method of specifying the location of a digital device comprising the steps of:
querying a location storage database based on an IP address and machine access code of the device;
determining if a known location of the device exists within the database; and
providing to the user a map display, geocoordinates, a civil address, and additional emergency services information associated with the location.

21. The method of claim 20, wherein if a location is not determined, said method further comprises the steps of:
inputting a device location from the device and another source;
determining the latitude and longitude of the input device location;
optionally comparing the input address with information in a master street address database; and
confirming that the device location is correct and providing additional services information to the user.

22. The method of claim 20, further comprising the steps of:
confirming that the location displayed was correct; and
entering the location data into a location storage database.

23. A method of communicating with non-IP based types of emergency services requests, said method comprising the steps of:
converting voice information from a request to a packet based voice over IP format;
converting non-IP data to a packet based IP format;
allowing multi-directional data flow between various system components; and
delivering the data and voice information between the various system components using the IP formatted information.

24. The method of claim 23, wherein said data and voice information can be shared among numerous applications.

25. A method of determining an appropriate recipient of an emergency services request, said method comprising:
determining a recipient for the request based on call information from one or more emergency services request originators; and
delivering the request to the appropriate destination.

26. The method of claim 25, wherein the delivering step further comprises forwarding the request to other emergency recipients.

27. The method of claim 25, wherein the determining step further comprises using information from additional information sources.

28. The method of claim 25, further comprising the step of communicating with a wireless carrier to access a mobile phone location.

29. The method of claim 25, further comprising the step of geocoding a civil address for use in the destination determination.

30. The method of claim 25, wherein said determining step uses session initiation protocol.

31. A subsystem for storing information concerning the emergency services requests, said subsystem comprising one or more:
civil routing storing means;
cell sector routing storing means;
coordinate routing storing means; and
means for storing information to support real time geocoding.

32. The subsystem of claim 31, wherein said civil routing storing means is for table based routing based on an MSAG valid address.

33. The subsystem of claim 31, wherein said cell/sector routing storing means comprises a table lookup based on a cell/sector location or coverage.

34. The subsystem of claim 31, wherein said coordinate routing storing means is for performing a spatial analysis to determine the public safety answer point associated with a latitude and longitude position.

35. The subsystem of claim 31, wherein said means for storing information supporting real time geocoding is for geocoding the address, determining the corresponding latitude and longitude and determining a public safety answer point or other recipient based on a civil address provided that is not master street address guide valid.

36. A subsystem of claim 35, further comprising means for providing possible alternative locations to the destination.
